(19) United States
(12) Patent Application Publication
(10) Pub. No.: US 2016/0332691 A1
(43) Pub. Date: Nov. 17, 2016

(54) LIGHTWEIGHT FORK ASSEMBLY

(71) Applicant: Fox Factory, Inc., Scotts Valley, CA (US)

(72) Inventors: William M. Becker, Aptos, CA (US); William O. Brown, IV, Aptos, CA (US); Daniel McCormick, Santa Cruz, CA (US)

(73) Assignee: Fox Factory, Inc., Scotts Valley, CA (US)

(21) Appl. No.: 15/154,156

(22) Filed: May 13, 2016

Related U.S. Application Data
(60) Provisional application No. 62/162,484, filed on May 15, 2015.

(51) Int. Cl. B62K 19/38; B62K 21/04; B62K 21/02

(52) U.S. Cl. CPC B62K 19/38; B62K 21/02; B62K 21/04

(57) ABSTRACT

A fork for a vehicle, the fork including: a set of first tubes; and a set of second tubes telescopically positioned within the set of first tubes, wherein at least one first tube of the set of first tubes comprises a recess configured for receiving at least a portion of a disc brake assembly.

### CROSS-REFERENCE TO RELATED APPLICATIONS

This application claims priority to and benefit of U.S. provisional patent application 62/162,484, filed May 15, 2015 entitled “LIGHTWEIGHT FORK ASSEMBLY”, by William M. Becker, having Attorney Docket No. FOX-P5-11-15-US.PRO, assigned to the assignee of the present application, and is incorporated herein, in its entirety, by reference.

### FIELD

Embodiments of the present technology relate generally to the field of wheeled vehicles.

### BACKGROUND

A mountain bike (MTB) or all-terrain bike (ATB) is a bicycle that is designed for off-road cycling where there is no man-made road surface. Mountain bikes evolved from both road bicycles and from off-road motorcycles. One view is that mountain bikes are road bikes that have been adapted to handle the more difficult and demanding off-road terrain. Another view is that a mountain bike is a lighter and human powered version of an off-road motorcycles (without motor), designed to reach those off-road areas that are inaccessible to off-road motorcycles (e.g. due to regulation and otherwise).

Since the development of early mountain bikes in the 1970s, many subtypes have developed, including cross-country (XC), freeride, downhill, and various track and slalom mountain bikes. Each places different demands on a mountain bike with the result that specialised designs and components have emerged to cater for each subtype.

For example, mountain bikes designed for downhill events have evolved with much stronger, but heavier components; a typical downhill mountain bike weighs about 18 kg (40 lbs). It is thought that many such downhill components have been adapted from off-road motorcycles.

In contrast, cross-country mountain bikes have evolved with much lighter components; a typical cross-country mountain bike weighs about 12 kg (26 lbs). Many cross country components have been adapted or borrowed from road bikes, where the requirement for lightness is paramount.

One area where weight reduction has been focused is the fork suspension where lighter materials and shorter suspension travel have been highly optimized. However, other trends in mountain bike design, such as 1) increasing wheel dimensions from 26″ to upwards of 29″ or more, 2) increasing wheel hub dimensions for strength, and 3) the replacement of rim brakes with disc brakes, have required increasing the fork dimensions to accommodate the larger components between the fork's two tubes. Thus there still exists a need for even lighter components in various types of bikes, such as, for example, the cross-country mountain bike while still accommodating ever increasing sizes of wheels and brakes.

### BRIEF DESCRIPTION OF DRAWINGS

The accompanying drawings, which are incorporated in and form a part of this specification, illustrate embodiments of the present technology for a lightweight fork assembly, and, together with the description, serve to explain the principles discussed below:

FIGS. 1A and 1B are perspective views of a fork leg assembly, in accordance with an embodiment.

FIGS. 2A and 2B are perspective partial views of a fork leg assembly, showing a set of lower leg tubes having a recess, a wheel hub, and a disc brake rotor, in accordance with an embodiment.

FIG. 3 is a perspective view showing a view from the underside of the fork leg assembly, which shows the underside of a set of lower leg tubes, a wheel hub and a disc brake rotor, in accordance with an embodiment.

FIG. 4 is a perspective view of a partial view of the fork assembly, showing a set of lower leg tubes, a disc brake rotor received into a recess of a lower leg tube and a wheel hub, in accordance with an embodiment.

FIG. 5A is a sectional view of a fork assembly, showing a set of upper leg tubes telescopically positioned within a set of lower leg tubes, recesses, stopper elements and a fork crown, in accordance with an embodiment.

FIG. 5B is a sectional view of a partial view of a set of lower leg tubes of a fork assembly, showing a set of lower leg tubes, recesses within the set of lower leg tubes, and stopper elements disposed adjacent to the recesses, in accordance with an embodiment.

### DESCRIPTION OF EMBODIMENTS

Embodiments of the present technology generally relate to fork assemblies. Certain embodiments relate to a fork assembly for a vehicle. Other embodiments relate to a fork leg tube of a fork assembly.

Embodiments of the present technology enable a lighter and narrower profile design for a fork assembly than that of conventional fork assemblies. As such, embodiments provide for a more aerodynamic bike. While embodiments are discussed herein in the context of a cross country mountain bike design, it should be appreciated that the concepts presented herein may be used in bikes other than cross country mountain bikes, as well as other types of vehicles.

Embodiments of the present technology provide one or more lower leg tubes that has a recess that is designed to increase the spacing between the opposing inner surfaces of lower leg tubes. As a result, the lower leg tubes realize several benefits. Although much of the below teachings and Figures describe one specific benefit of the recess (i.e. having the recess formed to accommodate a disc brake rotor), it should be understood that the present technology achieves numerous other benefits by forming a recess in at least one of the lower leg tubes. These numerous other benefits include, but are not limited to, for example, allowing a larger more robust hub to fit between the lower leg tubes. Additionally, by including a recess, the total weight of the lower leg tubes is reduced. It will be understood, by those in the art, that weight reduction is a much sought after and difficult result to achieve. Further, in some instances it may be desirable to use a much larger or wider tire. By increasing the space between the lower tubes, the present technology can readily accommodate such a larger or wider tire.

A conventional fork leg assembly includes two upper leg tubes that are connected to a fork crown at one end and that are telescopically positioned in one end of two lower leg tubes, such that the two upper leg tubes may slide in and out of the two lower leg tubes. Opposite the end at which the two upper leg tubes are telescopically positioned, a wheel hub connects the two lower leg tubes. Rotationally attached to this conventional wheel hub is a bike wheel. Also attached to the wheel hub is a portion of a disc brake assembly, such as a disc brake rotor. Thus, conventionally, the wheel and the disc brake rotor are positioned in between the outer surface of the walls of the two lower leg tubes, such that there must be enough room between the two lower leg tubes to accommodate the proper functioning of such components. Consequently, as the fork crown is attached to the upper leg tubes which are telescopically positioned along the same axis as the lower leg tubes, the width of the fork crown is approximately equal to the width of the portion of the wheel hub that lies in between the outer surfaces of the walls of the lower leg tubes.

Embodiments of the present technology provide one or more lower leg tubes that has a recess that is designed to accommodate at least a portion of the disc brake assembly, such as, but not limited to being, the disc brake rotor. Thus, for example, in one embodiment, an upper portion of a lower leg tube has a cylinder shape, while the lower portion of the lower leg tube is designed to include a recess such that the lower portion of the lower leg tube has a cylinder segment shape. The wheel hub attaches to the lower portions of the lower leg tubes. According to embodiments, when the wheel hub is attached to the lower portions of the lower leg tubes, the disc brake rotor that is attached to the wheel hub occupies the space that is provided by the recess in the lower portion of the lower leg tube(s). Once the wheel hub is attached to the fork assembly, since the disc brake rotor is now occupying an area that was previously occupied by (conventionally) walls of a lower portion of the lower leg tube, the two lower leg tubes may now be designed to be closer together since the smallest measured width between the two lower leg tubes need not account for the presence of the disc brake rotor still attached to the wheel hub (but which is now occupying the space provided by the recess). Of note, the depth of the recess provided in the lower portion of the lower leg tube(s) depends upon, amongst the following non-limiting examples of factors: the composition of the material of the lower leg tube(s); the size and shape of the upper portion and the lower portion of the lower leg tubes; and the type of bike and the expected stress that is anticipated to be placed upon such a novel design and combination of components.

According to an embodiment, since the two lower leg tubes may be designed to be closer together than conventional fork assemblies, it follows that the two upper leg tubes telescopically positioned at one end within the two lower leg tubes may also be designed to be closer together than conventional fork assemblies. As such, the fork crown that is attached to the other end of the two upper leg tubes may be designed to be narrower than conventional fork assemblies. Thus, embodiments provide for a more narrow profile fork assembly design, which allows for better aerodynamics for bike travel. Further, since the fork crown may be narrowed due to the narrowing of the width between the lower leg tubes and the upper leg tubes, the overall fork assembly becomes lighter than conventional fork assemblies. Additionally, in some embodiments, the recessed area provided within the lower portion of at least one lower leg tube, which presumptively, in one embodiment, creates a lower portion (of the lower leg tube) having a small circumference and therefore less material, also reduces the weight associated with the fork assembly.

Further, in one embodiment, the interior of the lower portion of the lower leg tube that has a “recess” disposed thereon is isolated from the upper portion of the lower leg tube, and as such, remains hollow, such that it does not hold any fluid. Therefore, compared to conventional technology in which the interior of the lower leg tube holds fluid, embodiments of the present technology will be lighter than those conventional lower leg tubes that hold fluid.

It should be noted that one or both of the lower leg tubes may include the recess described herein, regardless as to whether or not a portion of the disc brake assembly actually occupies only one of the recesses.

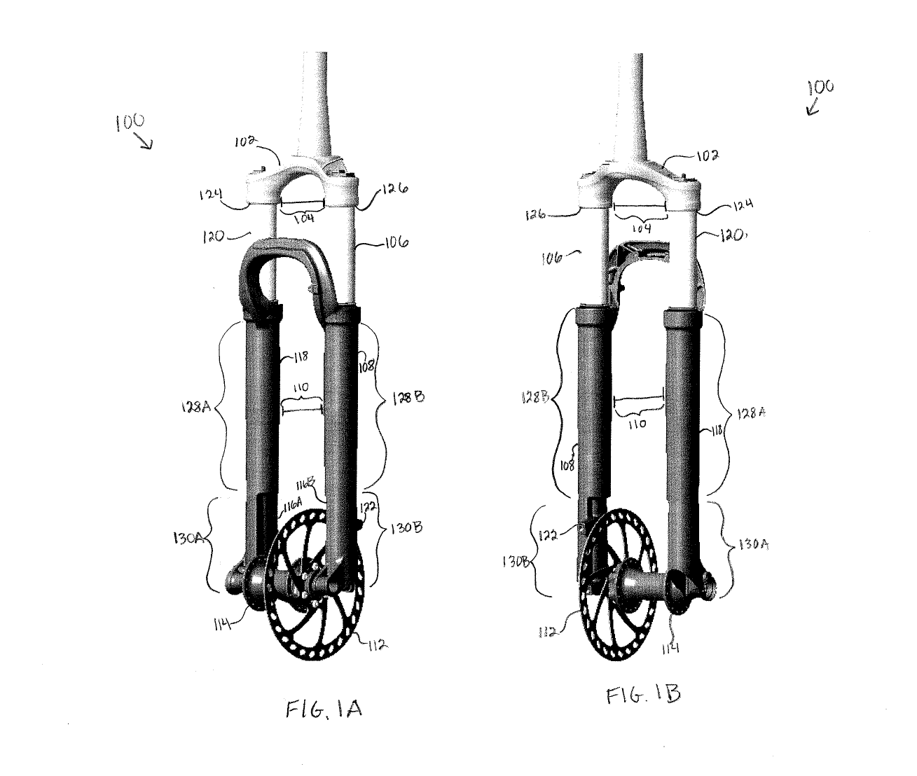

FIGS. 1A and 1B are perspective views of a fork leg assembly, in accordance with an embodiment. FIG. 1A shows the one end of the upper leg tubes 120 and 106 being attached to the receiving portions 124 and 126, respectively, of the fork crown 102, while the other end of the upper leg tubes 120 and 106 are telescopically positioned within the lower leg tubes 118 and 108, respectively. The receiving portions 124 and 126 of the fork crown 102 are separated by a width 104.

The lower leg tubes 118 and 108 include upper portions 128A and 128B and lower portions 130A and 130B, respectively. The lower portions 130A and 130B include the recesses 116A and 116B, respectively, in one embodiment. In another embodiment, only one of the two lower portions 130A and 130B includes a recess. In one embodiment, the recesses 116A and 116B are the same size. In another embodiment, the recesses 116A and 116B are of a different size. It should be noted that, for example, while the drawings show the upper portion 128A of the lower leg tube 118 having outer walls that are continuous with the outer walls of the lower portion 130A, except for the area of the recess 116A, in some embodiments, the outer walls of the upper portion 128A are not continuous with the outer walls of the lower portion 130A. For example, in one embodiment, the outer walls of the upper portion 128A may be of a circular tube shape, while the outer walls of the lower portion 130A may be of a rectangular shape. According to embodiments, various design aspects of embodiments depends upon various factors, such as, but not limited to being, the following factors: the strength of the materials used for the upper portion 128A and the lower portion 130A; the weight of the material used for the upper portion 128A and the lower portion 130A; the size and functioning of the disc brake assembly attached to the wheel hub and to the lower portion 130A (e.g., the disc brake caliper attached to the disc brake caliper mount 122); as well as other factors that put stress on the upper leg tubes 120 and 106 and the lower leg tubes 118 and 108 during use.

Still referring to FIG. 1A, it is seen that the wheel hub 114 is attached to the lower portions 130A and 130B of the lower leg tubes 118 and 108, respectively. It is also seen that the disc brake rotor 112 of the disc brake assembly is mounted on the wheel hub 114. Additionally, it is also seen in FIGS. 1A, 1B, 2A, 2B, 3, 4 and 5B that the disc brake rotor 112 is wholly received by the recess 116B. That is, the entirety of the disc brake rotor 112 is positioned within the recess 116B while the disc brake rotor 112 is mounted on the wheel hub 114 and the wheel hub 114 is attached to the lower portions 130A and 130B.

As such, it is also be seen that if the recess 116B was not there, then the disc brake rotor 112 would be touching the outer surface of the wall of the lower portion 130B of the lower leg tube 108 and hence would not function properly. Thus, if the recess 116B did not exist in the lower portion 130B, then the width 110 between the lower leg tube 118 and the lower leg tube 108 would have to be greater than that which is shown (width 110) since an area of clearance between the disc brake rotor 112 and the lower portion 130B of the lower leg tube 108 would be needed to allow for the disc brake rotor 112 to properly function (without the disc brake rotor 112 touching the outer wall of the lower leg tube 108 and still being attached to the wheel hub 114).

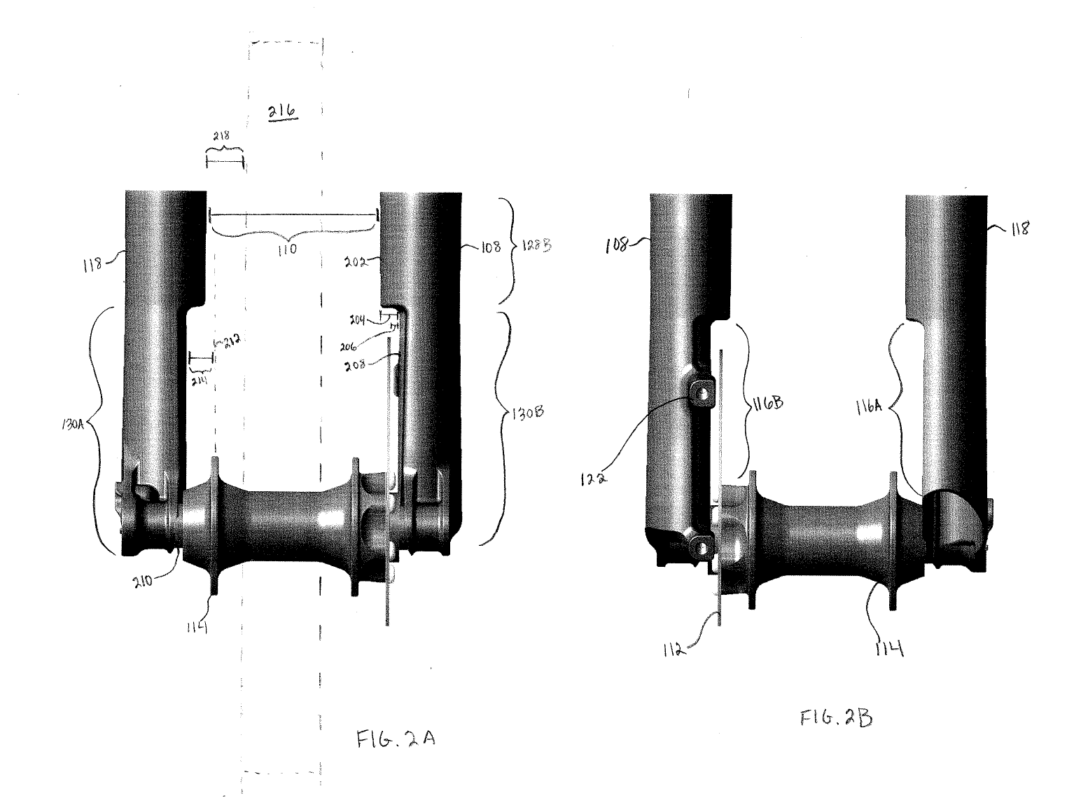

As can be seen in FIG. 1A, in one embodiment, since the recess 116B enables the disc brake rotor 112 to reside completely (partially in other embodiments) within the recess, in one embodiment, the width (in the design of a new fork assembly) between the lower leg tube 118 and the lower leg tube 108 may be decreased by taking into account the sum of the following structural occurrences to achieve the width 110 (Of note, FIG. 2A represents a fork whose profile has already been narrowed, while also accommodating the disc brake rotor within its recess): (1) (see FIG. 2A; should a recess be designed in the lower portion 130B of the lower leg tube 108) the distance 204 between the outer surface of the wall of the upper portion 128B of the lower leg tube 108 and the outer surface 208 of the wall of the lower portion 130B of the lower leg tube 108, minus the clearance 206 needed to enable the disc brake rotor 112, and hence the brake assembly, to function properly; and (2) (see FIG. 2A; should a recess be designed in the lower portion 130A of the lower leg tube 118) concerning the end of the wheel hub 114 opposite the side at which the disc brake rotor 112 is mounted, the distance 214 between the point 210 at which the end of the wheel hub 114 is attached to the lower portion 130A of the lower leg tube 118 and the point shown at approximately point 212, at which the wheel 216, should it be attached to the wheel hub 114, be allowed enough clearance 218 to properly function during use. The sum of (1) and (2) above represent just one embodiment in which a width between the lower leg tube 118 and the lower leg tube 108 is able to be decreased to become the width 110 that accommodates at least the proper functioning of the disc brake rotor 112 and the wheel 216 (and any other component involved in the area of the recesses 116A and 116B). It should be noted that, as discussed above, as the upper leg tubes 120 and 106 are telescopically positioned along the same vertical axis as the lower leg tubes 118 and 108, respectively, and the receiving portions 124 and 126 of the fork crown are receiving an end of the upper leg tubes 120 and 126, it follows that the decrease in the width between the lower leg tubes 118 and 108 to achieve the width 110 also enables the decrease in the width between the receiving portions 124 and 126 to achieve the width 104, such that the overall width of the fork crown 102 is approximately the same length (or an increase or decrease in such a width 110 would cause a proportional increase or decrease, respectively, in the width 104) as the width 110.

Thus, as can be seen, in one embodiment, the design of one or more recesses in the lower leg tubes 118 and 108 enables a reduction in the width of the fork crown (the fork crown's width reduction is necessary in order that the receiving ends 124 and 126 of the fork crown 102 may be attached to the upper leg tubes 120 and 106, respectively), and thereby also enables a reduction in the fork assembly's overall weight. Further, as can also be seen, the reduced width of the fork crown as well as the correspondingly reduced width between the lower leg tube 118 and the lower leg tube 108 results in a more narrow profile and consequently a more aerodynamic bicycle than that of a conventional bicycle.

In other embodiments, the resulting determined width 110 designed to accommodate the functioning of a wheel and a disc brake assembly varies according to the manufactured depth of the recess, the placement of the various components onto the wheel hub, the design of the wheel hub, the design of the lower leg tubes, etc. However, significantly, embodiments enable a fork assembly to have a more narrow profile than conventional fork assembly.

Again, although much of the above and below teachings and Figures describe one specific benefit of the recess (i.e. having the recess formed to accommodate a disc brake rotor), it should be understood that the present technology achieves numerous other benefits by forming a recess in at least one of the lower leg tubes. These numerous other benefits include, but are not limited to, for example, allowing a larger more robust hub to fit between the lower leg tubes. Additionally, by including a recess, the total weight of the lower leg tubes is reduced. It will be understood, by those in the art, that weight reduction is a much sought after and difficult result to achieve. Further, in some instances it may be desirable to use a much larger or wider wheel or tire. By increasing the space between the lower tubes, the present technology can readily accommodate other wheel structures such as wheel spokes extending from wider hubs to the rim and a larger or wider tire.

FIG. 1B shows the fork assembly 100 of FIG. 1A facing in the opposite direction. Additionally, the disc brake caliper mount 122 may be seen in FIG. 1B.

FIG. 2A shows, in accordance with an embodiment, a perspective partial view of the fork leg assembly 100, showing a set of lower leg tubes 118 and 108 having recesses 116A and 116B, respectively, a wheel hub 114 and a disc brake rotor 112. Further, a wheel 216 is shown, in one embodiment, as being mounted on the wheel hub 114. As can be seen in FIG. 2A, the disc brake rotor 112 is received in whole by the recess 116B such that there is adequate clearance between the disc brake rotor 112 and the outer surface of the lower portion 130B of the lower leg tube 108 and the wheel 216 for the disc brake rotor 112 to properly function.

FIG. 2B shows a partial view of the fork leg assembly 100 of FIG. 2A, facing in the opposite direction, such that the disc brake caliper mount 122 is seen, in accordance with an embodiment.

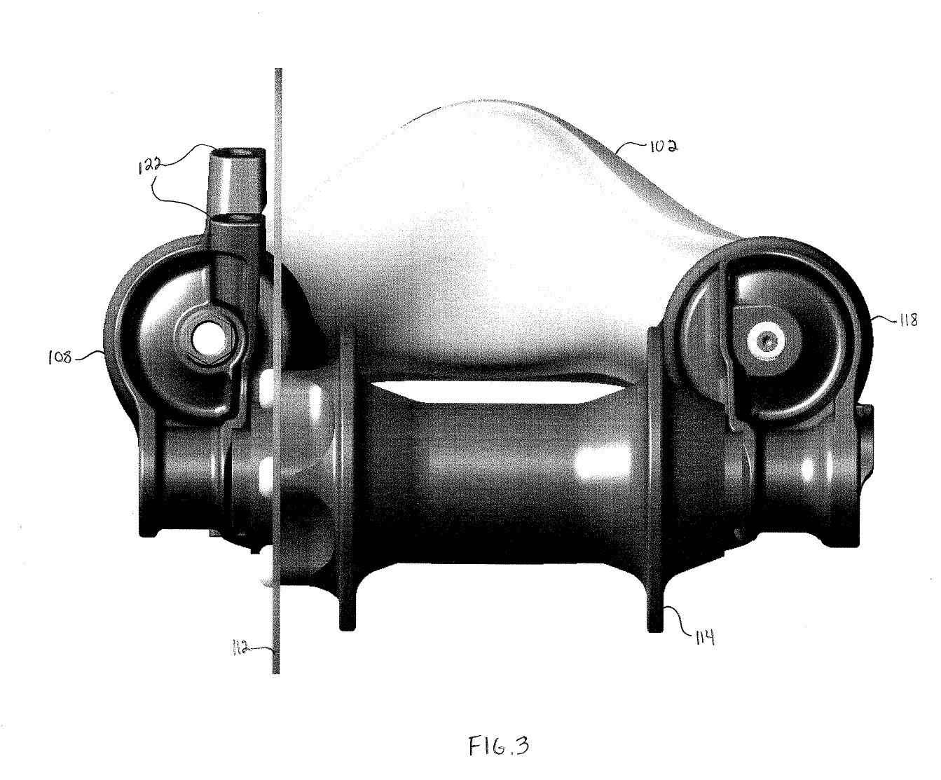

FIG. 3 shows, in accordance with an embodiment, a perspective view of the underside of the fork leg assembly 100. Shown is the set of lower leg tubes 118 and 108, the wheel hub 114, the disc brake rotor 112 and the fork crown 102. FIG. 3 shows the disc brake rotor 112 clearly within the formed recess 116B.

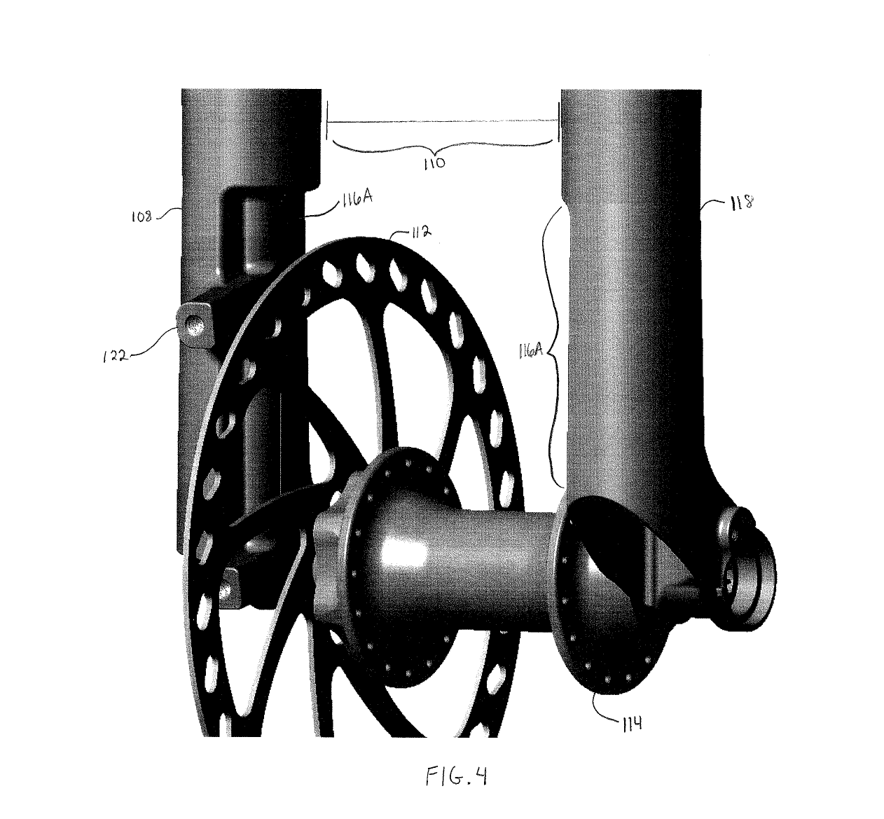

FIG. 4 shows, in accordance with an embodiment, a perspective view of the partial fork assembly 100. More specifically, FIG. 4 shows the set of lower leg tubes 118 and 108, the disc brake rotor 112 being received into the recess 116B of the lower leg tube 108, and the wheel hub 114.

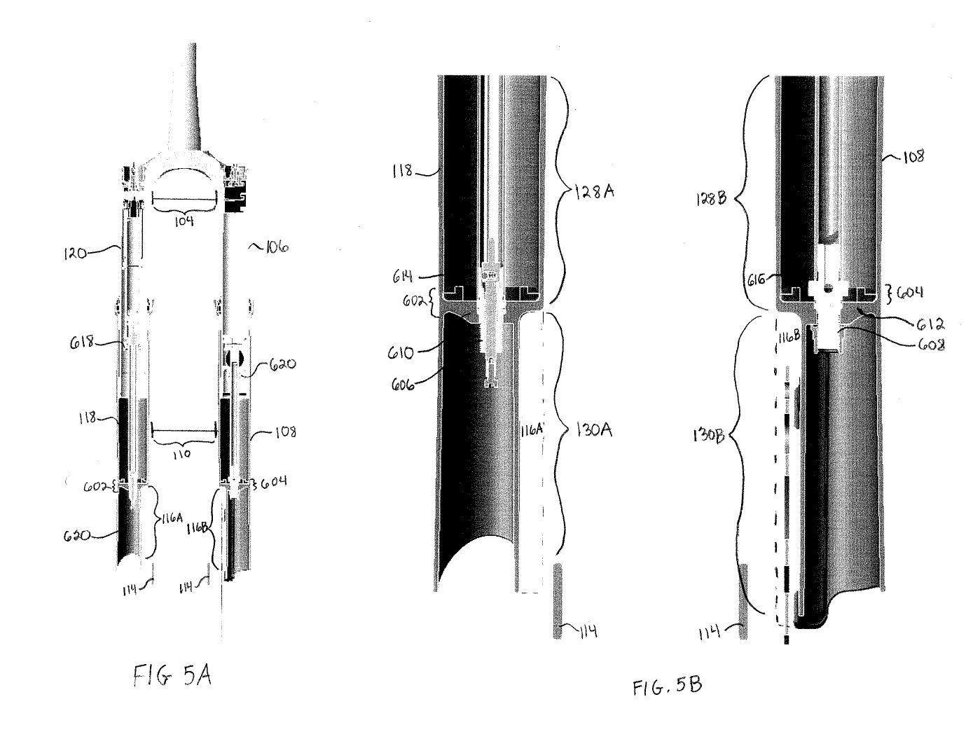

FIG. 5A is a sectional view of the fork assembly 100, in accordance with an embodiment. Shown is the set of upper leg tubes 120 and 106 telescopically positioned within the set of lower leg tubes 118 and 108, respectively, the recesses 116A and 116B, the stopper elements 602 and 604, and the fork crown 102.

FIG. 5B is, in accordance with an embodiment, a sectional view of the partial view of the set of lower leg tubes 118 and 108, of the fork assembly 100. Further shown are the recesses 116A and 116B within the set of lower leg tubes 118 and 108, respectively, and stopper elements 602 and 604, respectively, disposed adjacent to the recesses 116A and 116B.

As can be seen in both FIGS. 5A and 5B, the interior of the upper portions 128A and 128B of the lower leg tubes 128A and 128B, respectively, is isolated from the interior of the lower portions 130A and 130B. This isolation is accomplished using the stopper elements, 602 and 604, respectively. Below each of the stopper elements 602 and 604, the lower portions 130A and 130B of the lower leg tubes 118 and 108, respectively, are hollow; fluid does not enter the lower portions 130A and 130B. Included within the stopper elements 602 and 604 are portions of the piston assemblies 606 and 608, respectively, that reaches through the upper portions 128A and 128B from the upper leg tubes 120 and 106, respectively. The stopper elements 602 and 604 further include structural walls 610 and 612, respectively, disposed between the upper portions 128A and 128B and the lower portions 130A and 130B, respectively, and surrounding the portions of the piston assemblies 606 and 608, respectively, that reach through the upper portions 128A and 128B to the lower portions 130A and 130B. Additional components 614 and 616 may be placed above the structural walls 610 and 612, respectively, that serve to interact with the piston assemblies, such as the piston assembly portions 618 and 620, respectively, when the piston assembly portions 618 and 620 move toward the stopper elements 602 and 604, respectively.

It should be noted that the travel associated with the upper leg tubes 120 and 106 moving into the lower leg tubes 118 and 108 is restricted to the length up until the stopper elements 602 and 604. The upper leg tubes 120 and 106 would not fit into the lower portions 130A and 130B, respectively, of the lower leg tubes 118 and 108, respectively, due to the recesses 116A and 116B, respectively, positioned in the lower portions 130A and 130B, respectively. The stopper elements 602 and 604 further restrict the movement of the piston assembly portions 618 and 620, respectively, into the lower portions 130A and 130B, respectively.

With reference now to FIGS. 1A-5B, various embodiments of the present technology are further discussed.

In one embodiment, a fork for a vehicle includes: a set of first leg tubes; and a set of second leg tubes telescopically positioned within the set of first leg tubes, wherein at least one first leg tube of the set of first leg tubes includes a recess configured for receiving at least a portion of a disc brake assembly. In one embodiment, the set of first leg tubes are the lower leg tubes 118 and 108, while the set of second leg tubes are the upper leg tubes 120 and 106. In one embodiment, both of the lower leg tubes 118 and 108 includes recesses 116A and 116B, respectively, but only one of the recesses, recess 116B receives the portion of the disc brake assembly, the disc brake rotor 112. Again, although the present discussion describes one specific benefit of the recess (i.e. having the recess formed to accommodate a disc brake rotor), it should be understood that the present technology achieves numerous other benefits by forming a recess in at least one of the lower leg tubes. These numerous other benefits include, but are not limited to, for example, allowing a larger more robust hub to fit between the lower leg tubes; and accommodating a larger or wider wheel or tire.

In one embodiment, with regards to the fork for a vehicle, the first leg tube of the at least one first leg tube includes: a first portion; and a second portion that includes the recess, wherein the first portion includes a first circumference, and the second portion comprises a second circumference, wherein the first circumference is less than the second circumference. For example, in one embodiment, the first portion is the upper portion 128A (of the lower leg tube 118) that is of a first circumference, while the second portion is the lower portion 130A (of the lower leg tube 118) that is of a second circumference. In one embodiment, the first circumference corresponds to a shape of the upper portion 128A of the lower leg tube 118, and the second circumference corresponds to the shape of the lower portion 130A of the lower leg tube 118. These shapes may be different and have different circumferences, in one embodiment. In another embodiment, the circumferences of the upper portion 128A and the lower portion 130A may be the same, while each's respective shapes are different. Further, in one embodiment, the shape of the upper portion 128A, for example, may have a circumference that varies along its length (e.g., tapering, tapering at particular regions along a length of the portion, etc.), and the shape of the lower portion 130A, for example, may have a circumference that also varies along its length (e.g., tapering, tapering at particular regions along a length of the portion, etc.).

In one embodiment, with regards to the fork for a vehicle, the first portion, (such as upper portion 128A or 128B) may be composed of the same material, different material, or a combination of the two (same and different), than that of the second portion (such as the lower portions 130A or 130B).

Further, in one embodiment, the fork for the vehicle includes a recess that is configured for receiving at least a portion of a disc brake assembly, wherein this portion is the disc brake rotor 112. It should be noted that there may be other portions (one or more components) of the disc brake assembly that the recess also receives, in addition to, or in the alternative to, the disc brake rotor 112.

In one embodiment, the fork for a vehicle further includes a stopper element, such as the stopper element 602, that is disposed adjacent to an upper portion of the recess, for example, recess 116A, and interior to the first leg tube, for example, lower leg tube 118. During compression of the fork, the stopper element 602 restricts a portion of a piston assembly 618 from entering an area 620 within the lower leg tube 118 (interior of the lower portion 130B of the lower leg tube 118) that is adjacent to the recess 116A.

While the foregoing is directed to embodiments of the present invention, other and further embodiments of the invention may be implemented without departing from the scope of the invention, and the scope thereof is determined by the claims that follow.

What we claim is:

1. A fork for a vehicle, said fork comprising:
a set of first tubes; and
a set of second tubes telescopically positioned within said set of first tubes, wherein at least one first tube of said set of first tubes comprises a recess configured for receiving at least a portion of a disc brake assembly.

2. The fork of claim 1, wherein said first tube of said at least one first tube comprises:
a first portion; and
a second portion that comprises said recess, wherein said first portion comprises a first circumference, and said second portion comprises a second circumference, wherein said first circumference is greater than said second circumference.

3. The fork of claim 1, wherein said first tube of said at least one first tube comprises:
a first portion; and
a second portion that comprises said recess, wherein said first portion comprises a first circumference, and said second portion comprises a second circumference, wherein said first circumference is less than said second circumference.

4. The fork of claim 1, wherein said first tube of said at least one first tube comprises:
a first portion; and
a second portion that comprises said recess, wherein said first portion comprises a first circumference, and said second portion comprises a second circumference, wherein said first circumference is equal to said second circumference.

5. The fork of claim 1, wherein said first tube of said at least one first tube comprises:
a first portion; and
a second portion that comprises said recess, wherein a circumference of said first portion varies throughout said first portion and a circumference of said second portion varies throughout said second portion.

6. The fork of claim 1, wherein said first tube of said at least one first tube comprises:
a first portion; and
a second portion that comprises said recess, wherein said first portion comprises a material that is different from said second portion.

7. The fork of claim 1, wherein said portion of said disc brake assembly comprises:
a disc brake rotor.

8. The fork of claim 1, further comprises:
a stopper element disposed adjacent to an upper portion of said recess and interior to a first leg tube of said at least one first leg tube, wherein, during compression of said fork, said stopper element restricts a portion of a piston assembly from entering an area within said first leg tube that is adjacent to said recess.

9. A fork assembly comprising:
a fork crown comprising:
a first receiving end configured for receiving a first end of a first upper leg tube of a set of upper leg tubes; and
a second receiving end configured for receiving a second end of a second upper leg tube of said set of upper leg tubes;
a fork leg assembly comprising:
a set of lower leg tubes; and
said set of upper leg tubes telescopically positioned within said set of lower leg tubes;
a wheel hub removably attached to said set of lower leg tubes,
wherein a distance from said first receiving end and said second receiving end of said fork crown is proportionally sized according to a smallest width between outer surfaces of walls of said set of lower leg tubes, wherein said smallest width does not include an area there between in which a portion of a disc brake assembly is disposed, wherein said portion of said disc brake assembly is coupled with said wheel hub.

10. The lightweight fork assembly of claim 9, wherein said portion of said disc brake assembly comprises:
a disc brake rotor.

11. The fork assembly of claim 9, further comprising:
a distance between said outer walls of said set of lower leg tubes at which there is a largest width, wherein said largest width is greater than said smallest width, and said largest width includes a set of recesses disposed in at least one lower leg tube of said set of lower leg tubes.

12. The fork assembly of claim 11, wherein said set of recesses comprises:
one or more recesses.

13. A component of a fork assembly for a vehicle, said component comprising:
at least one lower leg tube of a set of lower leg tubes configured for telescopically receiving at least one upper leg tube of a set of upper leg tubes, wherein said at least one lower leg tube comprises a recess configured for receiving at least a portion of a disc brake assembly.

14. The component of claim 13, wherein said recess is large enough to fully receive said at least a portion of said disc brake assembly such that since all of said at least a portion of said disc brake assembly is received in said recess, a width between said set of said lower leg tubes does not accommodate a presence of said at least a portion of said disc brake assembly.

15. A fork for a vehicle, said fork comprising:
a set of first tubes; and
a set of second tubes telescopically positioned within said set of first tubes, wherein at least one first tube of said set of first tubes comprises a recess configured for increasing the distance between said set of first tubes.

16. The fork of claim 15, wherein said first tube of said at least one first tube comprises:
a first portion; and
a second portion that comprises said recess, wherein said first portion comprises a first circumference, and said second portion comprises a second circumference, wherein said first circumference is greater than said second circumference.

17. The fork of claim 15, wherein said first tube of said at least one first tube comprises:
a first portion; and
a second portion that comprises said recess, wherein said first portion comprises a first circumference, and said second portion comprises a second circumference, wherein said first circumference is less than said second circumference.

18. The fork of claim 15, wherein said first tube of said at least one first tube comprises:
a first portion; and
a second portion that comprises said recess, wherein said first portion comprises a first circumference, and said second portion comprises a second circumference, wherein said first circumference is equal to said second circumference.

19. The fork of claim 15, wherein said first tube of said at least one first tube comprises:
a first portion; and
a second portion that comprises said recess, wherein a circumference of said first portion varies throughout said first portion and a circumference of said second portion varies throughout said second portion.

20. The fork of claim 15, wherein said first tube of said at least one first tube comprises:
a first portion; and
a second portion that comprises said recess, wherein said first portion comprises a material that is different from said second portion.

21. The fork of claim 15, further comprises:
a stopper element disposed adjacent to an upper portion of said recess and interior to a first leg tube of said at least one first leg tube, wherein, during compression of said fork, said stopper element restricts a portion of a piston assembly from entering an area within said first leg tube that is adjacent to said recess.
